(19) United States
(12) Patent Application Publication
(10) Pub. No.: US 2007/0106897 A1
(43) Pub. Date: May 10, 2007

(54) Secure RFID authentication system

(76) Inventor: Michael Kulakowski, Jackson, NJ (US)

Correspondence Address: Michael Kulakowski, 5 Carlson Court, Jackson, NJ, 08527, US

(21) Appl. No.: 11/268,162

(22) Filed: Nov. 7, 2005

(51) Int. Cl. H04L 9/00

(52) U.S. Cl. 713/171; 455/411; 713/168

(57) ABSTRACT

A system comprised of computer hardware and software used to authenticate collectable/valuable consumer products (FIG. 3 element 310) utilizing a cellular telephone (FIG. 3 element 330)—containing an RFID reader device—authenticated as a “Trusted Reader”. The “Trusted Reader” cellular telephone reads an RFID tag (FIG. 5 element 320) attached to and/or embedded within a product to acquire an RFID tag's Electronic Product Code (EPC) (FIG. 5 element 322). The EPC unique id (and optionally other data) is transmitted over a Cellular Telephone Network (FIG. 5 element 340) to a Trust Authority (FIG. 3 element 370) to obtain an associated Public Key (FIG. 2 element 211) used in a cryptographic authentication challenge to authenticate an item against piracy and counterfeiting. The cellular telephone can transfer its data to a store Cash Register (FIG. 6 element 319) or Credit Card Reader to complete the purchase.

The RFID industry is poised for dramatic growth as small, inexpensive Radio Frequency Identification (RFID) tags provide an electronic serial number of an ID corresponding to a product. RFIDs can also contain cryptographic processors providing secure means of identifying the authenticity of an item.

An example of RFID usage to thwart counterfeit items is Winwatch a European company that embeds RFIDs into the crystals of expensive watches and provides stores and retail locations with readers that can check the authenticity of a product. However, in-store readers may not be convenient for consumers, may not be trusted, do not allow consumers to verify the authenticity of an item outside the store, do not link the authentication of an item to the sales of the product and have many other limitations.

This invention serves to eliminate these limitations and provide consumers convenient and secure methods to authenticate their purchases and to provide a system that trusted institutions could use to provide customers of the trusted institution added purchase protection to verify that the items purchased by customers of the institution are authentic. Trusted institutions can also provide “added buyer protection” privileges in the form of guarantying the authenticity of their products and purchases.

### LIST OF FIGURES

FIG. 1 provides a high level view of a typical cellular phone.

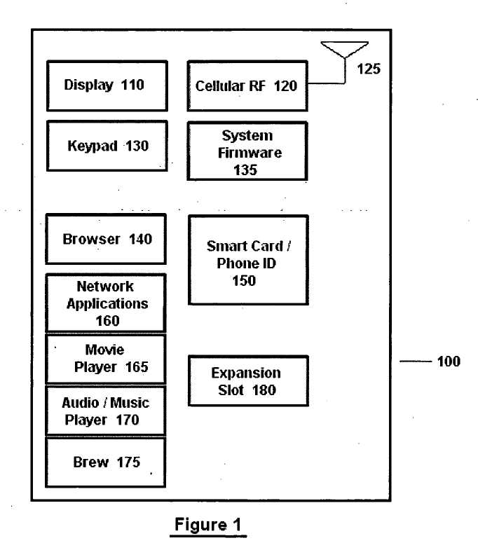

FIG. 2 provides a high-level view of a typical cellular phone with added Secure RFID Authentication System components.

FIG. 3 provides a view of the network and system components for Secure RFID Authentication System.

FIG. 4 provides an example of data stored in an RFID contained within a product or attached to a product.

FIG. 5 shows a Cash Register being integrated into the Secure RFID Authentication System.

FIG. 6 shows a credit card and credit card information integrated with the Secure RFID Authentication System.

FIG. 7 shows RFID contents used for authentication for products with different product values ranging from low value (inexpensive items) to high value (expensive items costing tens of dollars on up).

FIG. 8 depicts the Role of the Trusted Authority.

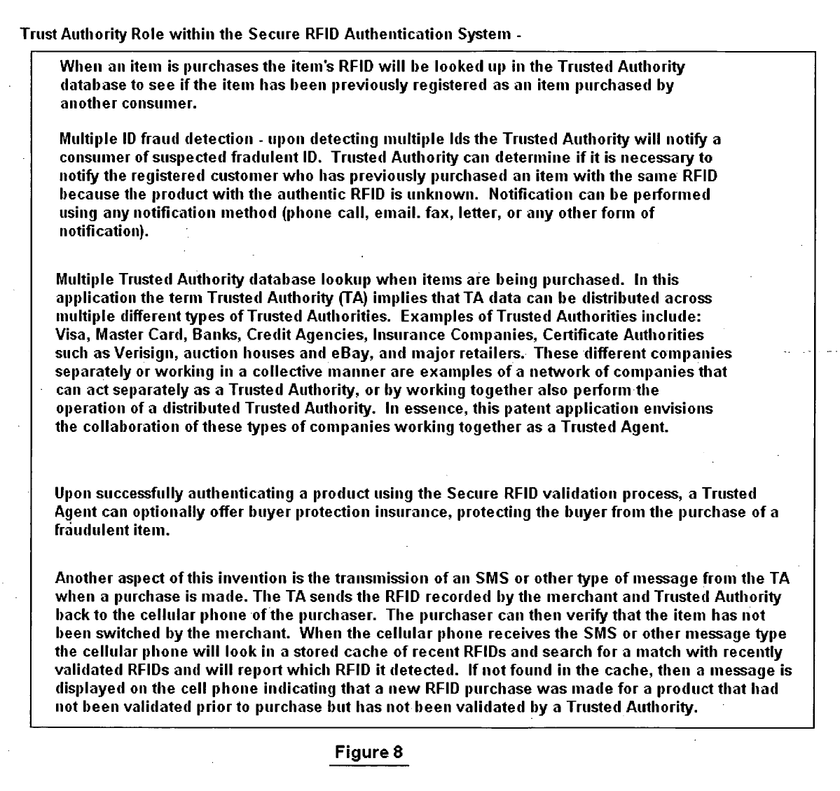

FIG. 9 RFID invention aspects.

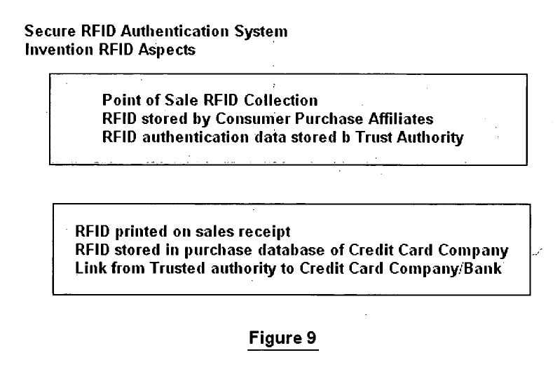

### DETAILS OF THE INVENTION

The Secure RFID Authentication System consists of hardware and software to allow consumers to authenticate products with RFIDs without needing a retail store to provide an RFID reader. In a preferred embodiment an RFID reader is incorporated into a cellular phone to allow the cellular phone to become a Trusted RFID reader. The Trusted RFID reader will allow consumers to verify that a product is authentic by using the RFID data contained within or attached to a product.

System Overview

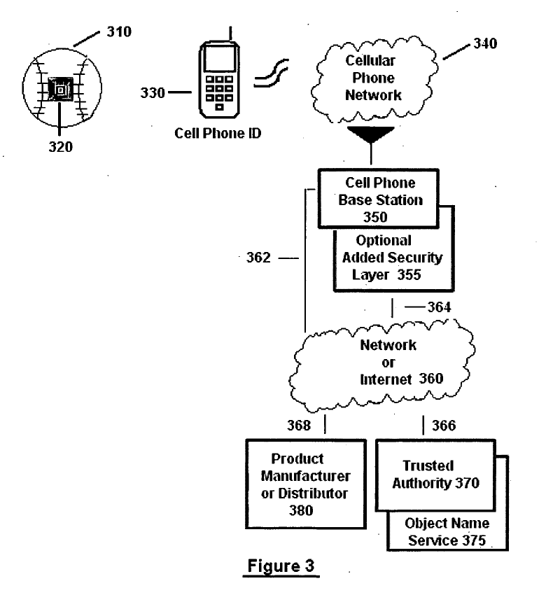

A typical system is presented in FIG. 3 showing an item 310 containing an embedded. RFID 320 tag. Item 310 is depicted as a baseball with an embedded RFID 320 in item 310. The RFID 320 contains at a minimum an Electronic Product Code (EPC) that contains a unique identifier for the product. Preferably, RFID 320 contains EPC and a cryptographically unique identifier. The cryptographically unique identifier contained with RFID 320 can be any type of cryptographic technique that provides a unique identifier that is based on private/public key encryption, secure passwords, message digest validation, secure challenge authentication protocols, authentication, non repudiation, and algorithms and techniques to guarantee the authenticity of an item.

In fact, it is expected that the techniques used to provide authentication of an item will evolve as new security methods are developed for securely identifying an item. Current day techniques that can be incorporated within RFID 320 to provide unique security and identification of a product include but are not limited to the following:

Symmetrical key encryption including DES, AES, IDEA, Blowfish, RC4, and other algorithms;

Public-key algorithms including RSA, Diffie-Hellman, DSA, and others; One-Way Hash Functions including SHA, RIPE-MD, MD4-3versions, MD5-2 versions, N-Hash, and others. Additionally, FIPS 196 other standards based authentication, encryption, key management, signed data, enhanced encrypted data (conventional & proprietary encryption), private/public key encrypted data, digested (hashed) data, authenticated (MAC'd), and others, encompass enhanced and accepted authentication methods incorporated by this invention.

In this patent application the term “secure communications” means communications that is encrypted using public/private key pairs, or symmetrical key encryption with keys shared between the communications points. “Secured communications” can also include authentication of communications points using Public/Private Keys, X.509 digital certificates, hardware encryption keys, secure processing elements, virtual private networks, and other methods and techniques used to establish authenticated and encrypted communications between two elements.

In this patent application the term “module”, “component” or “function” is used to describe the functionality of an operation regardless of where the operation is physically performed. Modules can execute directly within a cellular phone or can be distributed across a system or network and can run as a server side application, a web service, via an interface to a remote system using some form of Remote Procedure Call RPC, Secure Socket Layer (SSL) protocol with application code performing module functionality, using Microsoft .net or Simple Object Access Protocol SOAP, Java Script, Java Servlet, JSP, Java plug-in, native Java application, Web Services, Portal Applications, or any other actual implementation that can be used to perform the processing details for the module. Encrypted versions of the distributed communications, application code, APIs, and protocols necessary perform module functionality are also included in the term “module”.

Item 330 in FIG. 3 is a Secure RFID Authentication System enhanced cellular phone but item 330 can also be a PDA, appliance, notebook computer, desktop computer, television, cordless telephone, wireless device, or other product that can read RFID values from RFID 320 in item 310. The Secure RFID Authentication System enhanced cellular phone 330 shown in FIG. 3 also operates as a standard cellular phone within a cellular phone network 340. Cellular phone network 340 can be any type of wireless cellular phone network such as a GSM or CDMA technology based network offered by Sprint, Cingular or Verizon in the United States and can be based on any cellular phone technology and can include but does not require networking and web browsing features, Internet Protocol support, packet based communications and other standard cellular phone based networking, transport layer, and physical layer features. The invention described in this application document can also be based on wired and/or wireless network using wired telephone lines, Ethernet networking, wireless WIFI 802.11, Bluetooth, 900 MHz, 2.4 GHz, or other types of communications connections. Cellular phone network 340 represents the capability to remotely access another network or other computers.

Item 350 in FIG. 3 shows a Cellular phone Base Station where subscriber's cells phones can connect to other communications networks. Many cellular phone service providers allow customers Internet 360 access from their cellular-phones 330. Cell phone service provider will provide connection 362 shown between cell phone base station 350, network or Internet 360 and cellular phone 330.

Item 355 in FIG. 3 shows an optional added security layer that can be provided to securely connect cell phone base stations 350 to a Trusted Authority (TA) 370 and Product Manufacturer 380. Optional added security layer 355 provides a secure private network whereby communications between cellular phone base stations 350 are secured with other elements in the system 370 and 380. Additional security layer 355 can also be added to cellular phone 330 establishing a private network between cellular phone 330 and other elements in system 370 and 380. As will be discussed later, optional added security layer is not needed but can be added for enhanced security. Optional security layer 355 optionally connects to Trusted Authority 370 allowing Trusted Authority 370 to securely link to a Cellular phone 330 on the cellular phone network.

Optional security layer 355 allows Trusted Authority 370 to authenticate the communications between Trusted Authority 370 and Cellular Phone 330. Optional security layer 355 can also provide added authentication and security when Cellular Phone 330 is communicating with Product Manufacturer or Distributor 380. Any method of network and/or IP based security can be used for Optional Added Security Layer 355 between a Cellular phone company and a Trusted Authority. Examples include IP-SEC, Virtual Private Networks, Private/Public Key encryption and authentication.

Trusted Authority 370 in FIG. 3 can be a banking institution, a credit card company, a Certificate Authority company such as Verisign, a government agency, or another company that can be trusted by consumers. Trusted Authority 370 can also be a service provided by a Cellular phone Service provider. Trusted Authority 370 provides authentication of Product Manufacturer, Retailer, Distributor 380, allowing the consumerto authenticate the item 310 being purchased using embedded or attached RFID 320 to an item 310 via a cellular phone 330 connection to an authenticated product manufacturer 380.

Authentication Steps performed when consumer wants to authenticate an item:

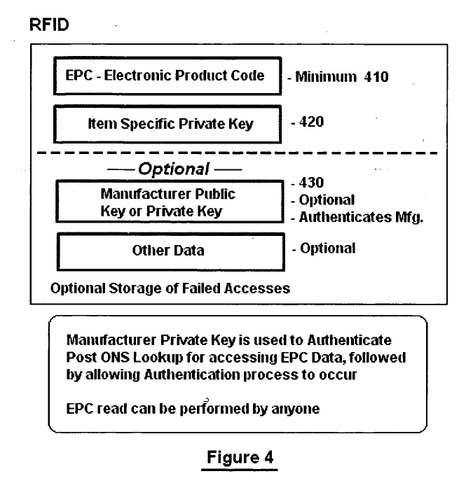

Phase 1: Authenticate Manufacturer—This phase reads information from the product, identifies the manufacturer from information contained within the product, and validates the manufacturer, allowing the consumer to verify the product is from the expected manufacturer. While not the complete authentication this step is the first phase in complete authentication.
1. Consumer selects item for authentication. Item shown is baseball 310 in FIG. 3.
2. Consumer holds cellular phone near product and presses Authenticate key on cell phone or Authenticate Menu Item on a Graphic User Interface on cellular phone 330 or via a menu or button on a Webpage or application that cellular phone is automatically (or manually) linked to during the reading stage of RFID 320 information. Cellular phone 330 can also be linked to a web service or validation server operated by Trusted Authority 370, cellular phone service provider, or another service provider used during the product authentication. Authenticate Menu can also be provided via firmware contained within the Cellular phone 330.
3. Cellular phone will read the RFID 320 contained in item 310.
4. Cellular phone 330 can optionally display information contained in RFID 320 on display of cellular phone 330. Information at this point from the RFID is not authenticated and an optional Warning Notice is provided that this information has not yet been authenticated. Display of unauthenticated information is optional and can be a user or system level selectable option. Warning message(s) can also indicate that authentication is in process.
5. Cellular phone 330 optionally stores the RFID 320 information in Cellular phone memory 330 or on a network 360 reachable storage area (customer's CellReader webpage, distributed to a customers email address, a log file provided by credit card service provider, an account provided by Trusted Authority, or by any other entity that will provide storage services for a consumer. Storage (not shown) of RFID 320 information provides a convenient list of items consumer may be interested in purchasing or researching at a later date. RFID 320 information stored for convenience of consumer allows consumer to perform additional searching and product research. Data stored at this stage can be the complete RFID for a particular product, or RFID information that will allow the consumer to use the stored information to later recall information regarding the product, but not necessarily the entire EPC for the product. Customer can add optional pricing information to the stored RFID at this stage for comparison price shopping or for other purposes.
6. After RFID 320 information is read from item 310 the manufacturer information associated with the RFID 320 is accessed from REID and used to identify and validate the product manufacturer. In this example the manufacturer of the baseball is Rawlings and a manufacturer ID for
   Rawlings is included in RFID 320. The manufacturer ID can be a Uniform Resource Locator (URL) for manufacturer such as www.rawlings.com, or a name or number assigned by Trusted Authority 370, or a service provider that operates authentication network. The RFID 320 contained within item 310 contains information to identify the manufacturer of the item 310, and the storage of manufacturer information for item 310 is expected to follow RFID industry standards. Manufacturer can be identified using Object Name Service standards established by the RFID industry to identify a manufacturer, or other techniques similar to Object Name Standards. Trusted Authority 370 will use Object Name Service 375 to identify manufacturer for customers using product authentication services offered by Trusted Authority 370.
   Trusted Authority 370 will validate manufacturer information contained within RFID 320 using manufacturer unique information such as the published public key for the manufacturer. Having the TA 370 send via phone 330 a value or challenge that gets signed by the RFID 320 contained in the product using the manufacturer private key 760 stored in the product RFID will be used to perform validation of the product manufacturer. Note that this manufacturer validation is not validating a unique product but rather only the product manufacturer. Validating the product manufacturer can be based on a hash or cryptographic calculation computed within the RFID 320 with manufacture private key 760 data contained within the RFID 320 that can be validated using public key data supplied by the manufacturer or TA 370 or a certificate authority such as Verisign. The way this optional manufacturer authentication will work is that each RFID 320 in a product will contain a manufacturer private key 760 in the RFID 320 that is used to digitally sign a message or respond to a challenge from the TA 370. TA 370 will authenticate the digitally signed message or challenge using the public key registered for this product manufacturer. This manufacturer private key 760 stored in RFID 320 is optional and in addition to a product specific private key 420. Product specific private key 420 is used to uniquely authenticate a single individual item, while manufacturer private key is used to authenticate a manufacturer of a product but not an individual item. In the above authentication a manufacturer specific private key 760 is stored in the RFID 320 and validated using the public key registered by the manufacturer with TA 370.
7. Manufacturer ID from item 310 is sent to network 360 via cellular network 340 and cell phone base station 350. Other network and/or communications paths can be used to transport the Manufacturer ID to Trusted Authority 370. Trusted Authority then identifies the correct manufacturer of the item 310. An optional feature of the system is to automatically connect the user to a web site or information location for the manufacturer of item 310. Another optional feature is that Trusted Authority 370 can authenticate the private or public keys for the Product Manufacturer 380 and/or the RFID 320 contained within item 310.
8. In FIG. 3 the Product Manufacturer or Distributor website or database access location is shown as element 380. A key element of the Secure RFID Authentication System is that the identification of the Product Manufacturer site 380 is not provided via a simple DNS name lookup as used with standard websites, but is identified by the Trusted Authority 370 or a trusted agent who provides secure name lookup of the manufacturer from the RFID 320 information. Trusted Authority 370 will provide more than just Object Name Service type lookup, and can authenticate the manufacturer 380 using manufacturer specific public or private key data 430 in FIG. 4 contained within Item 310, individual product unique private key data 420. Product Manufacturer information for item 310 determined by using information stored in RFID 320 can be authenticated using a digital signature or cryptographic hash using keys contained with RFID 320.
   Product manufacturer 380 can optionally be accessed via a secure or non-secure connection with cellular phone 330 after manufacturer is identified using information contained in RFID 320 is read as described above. Note, for lesser valued items manufacturer can be simply identified using non-secure data such as URL information for the manufacturer.

The above steps detail how a manufacturer can be securely authenticated using a product's RFID 320. However, the above steps did not authenticate an item 310, rather the above steps identified the manufacturer. The application code necessary to perform the above steps can be contained in the cellular phone 330 or via a web services type interface to a web service hosted by Trusted Authority 370. Or, the steps above can be distributed across Cellular Phone 330, Cellular Phone Network 340 Service Provider (or carrier), and Trusted Authority 370. When hosted by Trusted Authority 370 cellular phone 330 shall contain a means to securely connect to a web service provided by Trusted Authority 370. Any means that can be used to establish a secure connection between Phone 330 and Trusted Authority 370 can be utilized. Regardless of how the application is distributed between the cellular phone or provided by a network or Internet based application, script, portlet, or web service, the cellular phone 330 shall contain secure access method to perform individual product authentication and/or manufacturer authentication using key data contained with RFID 320 and processing steps described above.

Cellular phone 330 optionally includes RFID information storage or an RFID cache to allow authentication process or manufacturer lookup at a later time if no cellular phone coverage is available at the point of purchase. RFID cache will store RFID 320 information for products or items 310 that a consumer is interested in.

Authentication will occur automatically when cellular phone coverage is re-established, or can be performed manually by the user of the cellular phone 330. Stores can also provide wireless internet access using technology such as 802.11, Bluetooth, ZigBee, and other wireless communication methods to allow Cell Phone 330 to access Trusted Authority 370 without using wireless network. Trusted Authority 370 will use Phone unique information such as Smart Card/Phone ID data or cryptographic data contained within Phone 330 to authenticate a Cell Phone 330. Communications between TA 370 and Phone 330 can be encrypted using Cell Phone 330 unique information such as SIM information or a Cell Phone ID that is used to encrypt information between the TA 370 and Phone 330, or a TA 370 public key securely stored in the Phone by the TA 370 or distributed across Phone 330 and cell phone service provider. Cell Phone ID can be SIM card data as used by standard cellular networks, or it can be a private key stored in Phone 330 that is used with a public key registered with a Certificate Authority for Phone 330.

The process described above provides a secure method to access the correct product manufacturer for an item. After the manufacturer is properly Authenticated using any or all of the Authentication methods described above a product Authentication Step can be selected by the user or automatically performed after the manufacturer was authenticated when a consumer wants to authenticate an item using Cell Phone 330:

Phase 2—Authenticate an Item

1. The EPC code in RFID 320 obtained from the product is sent from Phone 330 to Product Manufacturer 380 via network 360 via route 368 or via a connection 368 from network to Trusted Authority 370 and Manufacturer 380 (not shown). If communications is from Phone 330 to Trusted Authority 370 (or distributed processing site for Trusted Authority 370) Trusted Authority 370 will connect to Product Manufacturer 370 and transfer EPC code to Manufacturer 380. If communications is from Phone 330 to Product Manufacturer 370, Phone 330 will transfer EPC code to Manufacturer 380.
2. Transferring of EPC data from RFID 320 via Cell Phone 330, Cellular Network 340, Network 360 to Product Manufacturer 380 is encrypted using the public key of Product Manufacturer 380 or via the TA 370 using Phone 330 to TA 370 encrypted communications. The public key of the Product Manufacturer 380 can be obtained either from the RFID 320, the Trusted Authority 370, Cellular Network Provider, or Manufacturer 380, or a service that will provide Public Key distribution such as a Certificate Authority. In this invention the public key for the Product Manufacturer can be obtained using any of the sources listed above (Cellular phone service provider, Trusted Authority 370, Object Name Server 375 hosted by Trusted Authority 370 or cell phone service provider or another party, or directly from the manufacturer 380.) Note this data can also be encrypted using the public key by the Phone 330 of Trusted Authority 370 when Trusted Authority 370 authenticates the item with Manufacturer 380. Phone 330 will receive messages encrypted by the TA 370 with the TA 370 encrypting the messages going to the Phone 330 using the private key of the TA370 and the Phone will decrypt the message using the Public Key of the TA. The use of Trusted Authority 370 to receive EPC encrypted data (in this case using the public key of the Trusted Authority 370) is also supported by this invention allowing TA 370 to authenticate item 310 instead of Manufacturer 380. Additionally, TA 370 can digitally sign Manufacturers 380 validation response to allow Phone 330 to know TA 370 is authenticating the Manufacturers 380 response to authenticating an actual item.
3. Upon receiving the EPC data from RFID 320 encrypted with the public key of the Manufacturer 380 (or public key of Trusted Authority 370 when TA 370 is performing authentication for Product Manufacturer 380), EPC data is decrypted using the private key of Manufacturer 380 (or private key of Trusted Authority 370 when TA 370 is performing authentication for Product Manufacturer 380).
4. Upon decryption of EPC data Product Manufacturer 380 (or Trusted Authority 370) will use the public key for the private key store in RFID 320, so that Product Manufacturer 380 (or Trusted Authority 370) can generate an authentication challenge for the RFID 320 in product 310. Authentication challenge can be any type of challenge used to authenticate an item using public/private key infrastructure and/or encryption. The Authentication Challenge generated by Manufacturer 380 (or Trusted Authority 370) is encrypted with the public key that is paired to the item specific private key 420 in the RFID 320 contained in item 310.
5. Authentication challenge is sent back to RFID 320 contained with item 310 via network 360, cellular phone service provider, cellular phone network 340, and phone 330.
6. Authentication challenge is received by RFID 320 and decrypted using the item specific private key 420 for the RFID 320 and applying any message/password SALTing, de-scrambling, de-interleaving that was applied to the authentication challenge.
7. RFID computes required message hash, message digest, digital signature, or other computation and then signs computation with RFID 320 item specific private key 420 and sends signed computation back to Manufacturer 380 (or Trusted Authority 370) via Phone 330 and network.
8. Optionally, after RFID 320 computes required message hash, message digest, digital signature, or other computation and then signs computation with RFID 320 item specific private key 420, the RFID can encrypt the message going back to Manufacturer 380 (or Trusted Authority 370) with public key of Manufacturer 380 (or Trusted Authority 370) and then sends encrypted signed computation back to Manufacturer 380 (or Trusted Authority 370).
9. Manufacturer 380 (or Trusted Authority 370) will validate the digitally signed authentication challenge to verify the RFID device using the public key information for the item specific private key 420 stored in RFID 320.
10. Upon validation, results will be sent back to the Phone 330. The sending of the validation data will be encrypted using the private key of the Manufacturer 380 (or Trusted Authority 370) and decrypted in the phone using the public key for the entity (Mfg. 380 or TA 370) that validates results.

An optional additional step at this point can have the Manufacturer 380 sign the validation results using the Manufacturers 380 private key and the Trusted Authority 370 validating the Manufacturer 380 signed validation results and then the Trusted Authority 370 will send the authenticated signed validation results to the phone 330. Having the TA 370 authenticate the signed validation results may be preferred by the TA 370 when the TA 370 provides buyer protection insurance as a member benefit for using the TA's 370 RFID 320 authentication or product authentication service. When TA 370 provides RFID 320 authentication results to phone 330 then the TA 370 will securely communicate with Manufacturer 380 to authenticate product and TA 370 will receive product RFID 320 that will be used to identify the product being authenticated. The validation results can be optionally encrypted uses Phone 330 SIM module data or cryptographically unique information for Phone 330.
11. Optionally validating the history of item 310 and RFID 320 to verify seller has appropriate rights to sell product.

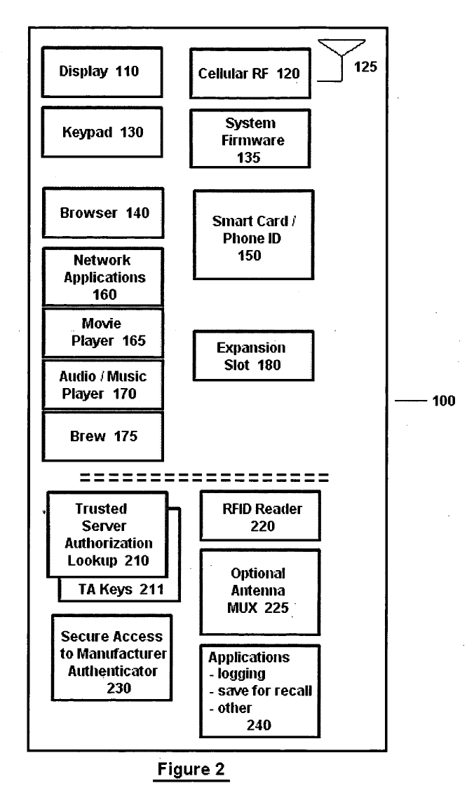

Referring to FIG. 2 to support the Secure RFID Authentication System's system the following elements will be added to a cellular phone:

In this application the term cellular phone is used but the same technology can be added to Personal Digital Assistants (PDA's), telephone handset, watches, handheld authenticator/RFID readers, laptop computer, desktop computer, bar code reader/scanner, printer, copier, fax machine, router or network equipment, standalone appliances, or other type of electronic device to provide a secure, or even trusted RFID reader that incorporates the benefits of this invention. Trusted RFID readers will include cryptographically unique keys to allow TA 370 to authenticate a trusted Reader. FIG. 2 shows the elements being added to a cellular phone.

In FIG. 2, Display 110, keypad 130, Cellular RF 120, antenna 125, system firmware 135, browser 140, network application 160, movie player 165, smart card/phone ID 150 (also known as Subscriber Identity Module SIM), audio player 170 are standard hardware and software components found in a cellular phone. BREW 175 represents Qualcomm Incorporated cellular phone application environment and this element can also include or consist of a Java execution environment to run Java code, or other application framework/runtime environment for cellular phones. Expansion slot 180 can be a Compact Flash, PCMCIA, PCI, Secure Disk SD Memory or some other type of expansion slot for plug-in devices.

In FIG. 2 antenna 125 and cellular RF 120 can be standalone GSM or CDMA type circuitry used for transmitting/receiving cellular phone signals using antenna 125. However, this invention also can include optional antenna multiplex (mux) 225 to allow RFID reader 220 circuitry to use either a separate RFID reader antenna (not shown) or to have RFID reader 220 circuitry connect to antenna 125 via optional antenna mux 225.

Trusted Authorization Server Lookup 210 functionality performs functions similar to Domain Name Server (DNS) or Object Name Service (ONS) lookup for standard Internet domain name lookup but does so from a Trusted Authority 370 (FIG. 3) or other trusted institution. Trusted Authorization Server Lookup 210 extends DNS or Object Name Service (ONS) that performs lookup of an RFID EPC to identify the manufacturer and provides authentication of the actual server returning the ONS lookup results. For this invention the use of DNS and ONS are synonymous and can be interchanged in functionality. When a DNS server is used in this invention the step of reading a manufacturer ID and converting the manufacturer ID to a Uniform Resource Locator or IP address for the manufacturer's website or network is included in the DNS step. When the term ONS is used in this invention the process of finding an object's information from the Electronic Product Code (EPC) which is stored in the RFID embedded within an object is implied by the term. Even though DNS and ONS are different functions the use of each function DNS or ONS includes any other functions required to perform the lookups described in this invention. For example, a DNS lookup with TA 370 can include ONS lookup if necessary and other look ups and is not limited to only traditional DNS lookup functions. The same goes for ONS where ONS in this patent application includes extended functional lookup such as DNS and others beyond what a standard ONS server may lookup. In the RFID industry an ONS server establishes a connection between an object identified by an EPC in the object and its information on distributed databases. This invention requires the Trusted Authority (or service provider) to authenticate the ONS server whereby the ONS server after authentication by the Trusted Authority will provide an authenticated network address link between the RFID and manufacturer.

A DNS/ONS service lookup/access session or public key shown as Trusted Authority TS Key(s) 211 for the Trusted Authentication Server Lookup function 210 is shown in FIG. 2. Trusted Authority TS Key 211 can also be used to secure communications between Phone 330 and TA 370. TS Key 211 can also be used during service lookup/access functions allowing Phone 330 to encrypt messages that can only be decrypted by TA 370 during lookup authentication. Trusted Authorization Server Lookup 210 function can also be distributed between software running in Phone 330 and functions running on cellular phone network or functions running on TA 370 computers. TS Key 211 (or similar key not shown) can be used as a DNS/ONS service lookup/access session key to make sure that Phone 330 is not using a rogue DNS/ONS service provider during authentication. Trusted Authorization Server Lookup 210 function also provides secure communications between Phone 330 and TA 370 in addition to ONS/DNS lookup functions and is used to decrypt validation messages returning from the TA 370. Validation messages will be encrypted with using the private key of the TA 370 and can be decrypted by the TA 370 public key stored in Phone 330. Key hierarchy for Phone 330 access to TA 370 is based on symmetrical key encryption or public/private key encryption and can be based on a single key or multiple keys stored in Phone 330. An example of the keys used to protect Phone 330 to TA 370 is shown below, and can be performed using a single key or multiple keys.

| TA 370 related key stored | |
|---|---|
| in Phone 330 used to | |
| authenticate communications | |
| between Phone 330 | |
| and TA 370. | |
| Key: | Function: |
| Public Key of TA 370 | Used to encrypt messages between Phone |
| | 330 and TA 370. |
| DNS/ONS key | An optional key shown in TA key(s) 211 |
| | that can be used to encrypt and |
| | authenticate DNS/ONS functions and |
| | lookup. |
| Session Key of TA 370. | An optional key in TA Key(s) that allows |
| | session based symmetrical key encryption |
| | between Phone 330 and TA 370 allowing |
| | for faster transactional throughput than |
| | systems using PKI encryption for all |
| | communications. |
| Authentication access | Optional password or key used to allow |
| password or key. | TA 370 to perform cryptographic |
| | authentication functions provided by |
| | RFID 320. When this key is used the |
| | normal state of the RFID 320 is to not |
| | respond to any authorization requests |
| | until this optional key/password is |
| | provided by the TA 370. |

In the above table the TA 370 related key stored in Phone 330 is used to authenticate communications between Phone 330 and TA 37, however this key hand/or the authentication method can be distributed amongst the Phone 330 Cellular Phone Network 340, or Cell Phone Base Station 350. This means that Phone 330 does not need to do the complete authentication of TA 370 and authentication can be distributed with a secure communication link between the Phone 336 and the TA 370.

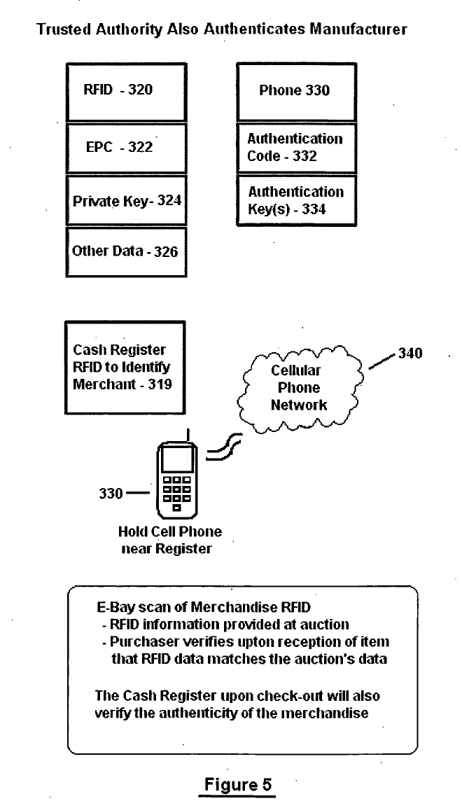

Referring now to FIG. 5, the RFID 320 information can be transferred to the store Cash Register 319, or RFID 320 information can be read by a RFID reader in Cash Register 319 when a consumer is paying for purchases. Cash register will obtain or read RFID 320 information from product and transfer RFID 320 information from Cash Register to entity performing product authentication (TA 370, Manufacturer 380 or even store itself (not shown)). Phone 330 will provide a Cell Phone Identifier to Cash Register 320 to allow authentication results to be returned to Phone 330. Information provided by Cell Phone 330 to Cash Register 319 is called Cell Phone Identifier and is sent from the phone to cash register 319 and can be the cellular phone telephone number, or preferably an identifier that cannot be used by the merchant to capture the telephone number of the consumer. Cell Phone Identifier can be a code known only to the Trusted Authority 370 and can be securely sent to the Trusted Authority with the Cell Phone Identifier encrypted using the public key of the TA 370 before the cell phone 330 sends the Cell Phone Identifier to the TA 370 via the Cash Register 319. Alternatively, but less desirable, Cell Phone Identifier can be sent alone with RFID 320 information to TA 370 from Cell Phone in parallel to the Cash Register 319 sending RFID 320 information to TA 370 during checkout to allow customer to independently authenticate RFID 320 of item, in addition with allowing store to authenticate an item. Cell Phone Identifier will be of no value except to the TA 370 or Credit Card Company because it is an identifier not known to the public and can be encrypted using the public key of TA 370 or Credit Card company and can contain random data fields to obfuscate the Cell Phone Identifier. Cell Phone Identifier can be sent from Phone 330 to Cash Register 319 via any wireless communications technique such as infrared, RF (Bluetooth, ZigBee, 802.11, others), using the RFID communications link to communication between the Phone 330 and Cash Register 319 or other communication method when Phone 330 communicates to Cash Register 319. Authentication information (results) for a product can also be transferred to Phone 330 via TA 370, Manufacturer 380, or Credit Card Processing company (not shown) using Phone 330 identifying information supplied by Cell Phone owner to TA 370, Manufacturer 380 (less desirable), or Credit Card Processing company (not shown but act like TA 370).

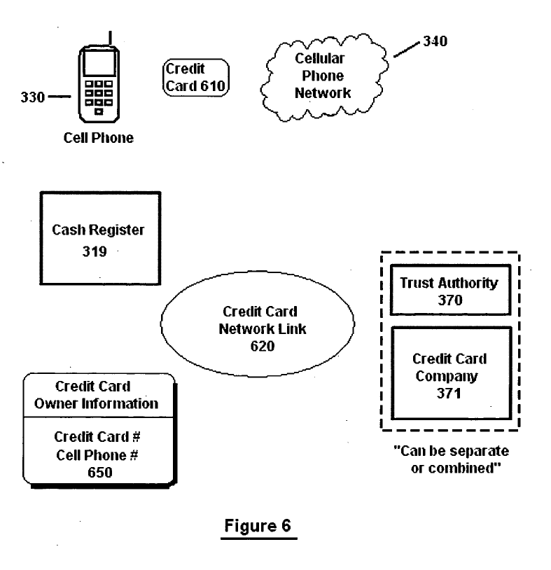

Referring now to FIG. 6, this invention allows the Phone 330 and phone user to be associated with Credit Card 610 allowing purchases to be authorized by a cellular phone user or allowing product authentication results to be sent to Phone 330 via identification of Phone 330 from Credit Card 610 information. Credit Card Company 371 upon receiving purchase information from store or store Cash Register 319 will identify Phone 330 from owner information of Credit Card 610. Credit Card Company 371 can act as Trusted Authority 370 combined together in the dashed lines in FIG. 6 or they can be separate companies linked via secure communications. Purchase authentication information can be returned from TA 370 or Credit Card Company 371 to Phone 330 over Cell Phone Network. Shown in FIG. 6 is Credit Card Number information stored with Cell Phone Number of Credit Card Owner in 650. This Credit Card Number/Cell Phone Number information will be stored in Credit Card Company 371 database information. If TA 370 is separate from Credit Card Company 371 than Credit Card Company 371 can transfer purchase information (RFID number of product being purchased/authenticated) to TA 370 so that TA 370 can authenticate product being purchase with validation results sent back to Phone 330 from TA 370 or even Credit Card Company 371 when TA 370 and Credit Card Company cooperate in authenticating purchases.

TA 370 or Credit Card Company can automatically provide product registration based on purchase information received by Credit Card Company including Credit Card Number, and RFID of purchased product. Credit Card Company determines manufacturer of product and can register customer for product warrantee service if desired by customer. Customer is identified by credit card number, RFID information identifies the product and manufacturer of the product purchased by customer. Credit Card Company will generate product warrantee registration form that is securely sent to warrantee provider of product purchased by consumer along with an optional copy of warrantee information to consumer. Consumer can at a later date retrieve warrantee information from Credit Card Company or TA 370 because this information can be archived by Credit Card Company for customer.

Product manufacturer database can automatically be updated with purchase information from retail store if desired by consumer. History of purchases can be recorded for customer providing details on the item, serial number, EPC, purchase date, purchase location, and other information automatically using system shown in FIG. 3.

Wireless link from cash register/credit card processing to cell phone to track purchases. Interface to cellular phone can be bluetooth, 802.11, zigbee, RFID emulation, etc.

Secure handshake

Info exchange

In addition to authentication, Secure RFID Authentication System provides secure lookup of a product RFID, eliminating the potential for a competitor of the product manufacturer to substitute their product and RFID information for a legitimate product This secure lookup guarantees that a consumer will be linked with the true, legitimate manufacturer of a product.

Alternative Authentication Process:
1. Cell phone user presses Authentication button or Menu Item provided by Cell Phone Graphic User Interface or voice command user interface.
2. Cell phone reads EPC from RFID
3. EPC is processed for ONS information by Trusted Authority or service provider or via standard ONS processing step.
4. ONS service provides network address information for Manufacturer.
5. Consumer's Phone is liked to Manufacturer via ONS.
6. Consumer can get information from Manufacturer website
7. If Authentication is required—a first optional step as follows is performed: manufacturer (MFG) is authenticated by having the RFID generate a random number or message digest of some information (URL for MFG plus other data). Message is encrypted with public key of Manufacturer. Message is sent to Manufacturer. Manufacturer decrypts message using Manufacturer private key, creates a new message digest or modifies the message in a known way and then encrypts the message with private key of manufacturer, and after encryption manufacturer sends newly encrypted, updated message back to RFID. RFID authenticates the response using the Manufacturers Public Key and if authenticated will allow the rest of the authentication process to continue.
8. Optionally, Trusted Authority if TA does not provide ONS server lookup can authenticate the RFID for the item being purchased and securely provide the authentication results back to the Phone 330 using a secure transmission method between TA 370 and Phone 330.

An optional way this invention works is by having the manufacturers Public Key contained in the RFID that will allow the RFID to be used by various service providers or Trusted Authorities without having to have Trusted Authority information contained within RIFID. This allows RFID to use any Trusted Authorities, or even non-Trusted Authorities to establish a secure link to manufacturers. However, the problem with the storage of manufacturers Public Key in RFID is that any manufacturer can generate a public/private key pair and store the manufacturer public key in a product and unless the manufacturer public key is verified by a trusted authority the consumer will not know the manufacturer is authenticated, only that the RFID contains a valid public key for some manufacturer.

Trusted Authority will authenticate the manufacturer before a consumer purchase is completed when Trusted Authority or service provider provides consumer buyer protection.

Cellular phone 330 becomes “trusted” by a consumer because phone 330 Authenticates Trusted Authority either using software in phone, by web service or network provided service. Cell phone network (Cell Phone Base Station 350 and other components) can also be used to authenticate Trusted Authority 370, instead of, or in addition to the authentication performed by phone 330. This means the phone itself, or the cellular phone network provider can assure that the Trusted Authority 370 is authenticated.

The above product authentication methods can be applied to authenticate items sold over eBay and other similar auction sites. Consumers can use their cellular phone to authenticate items purchased using eBay when the consumer receives the item.

Authentication Will Work as Follows:
1. eBay can request or require seller to list RFID for products being sold.
2. eBay will verify the product RFID as being authentic using the product authentication steps described above for low, medium, or high value items.
3. Seller will show RFID information for product offered for sale. EBay can link the product auction and RFID and optional RFID validation information to the auction offering information.
4. Buyer can press an eBay supplied Verify Product button shown on the Internet web page for the product listed on eBay. Or eBay will add an indication that the RFID for the product being listed in the web page for the product being sold has had the RFID product ID validated by eBay. If eBay shows that eBay has validated the item being offered for sale, eBay will indicate this validation via a secure insertion into the auction offering page for the item being auctions. This validation indicator is added by eBay in such a manner that insures the validation information cannot be added by the auction seller.
5. Buyer will make an auction offer for the product being sold using the eBay ‘place bid’ method currently used by eBay in its service. When buyer ‘places bid’ RFID will be stored for person making the bid such that the bidder can at a later date verify that the item's RFID information is the same as the one the person had bid on. eBay will include the RFID for the product being bid on in auction notification information and auction transactional records. If an eBay user is successful in purchasing the item on eBay, eBay will record the product RFID in the eBay transaction database. Now, both eBay and the customer have the RFID data offered for sale.
6. Upon receipt of the product by a customer, the customer can use their cellular phone or RFID reader and validate the product being purchased using validation service offered by eBay, or a TA 370 or other service provider. EBay can provide a web service to allow customers to scan an RFID tag and have the RFID tag authenticated and verified as the same item they had bid on and that the item is authentic.

In addition, this invention allows consumers and eBay to detect stolen property using stolen property RFID information. Because a consumer can at a later date update an RFID database with stolen RFID EPC codes, eBay can check the RFID information in the stolen database before allowing a seller to list a product with eBay. When an item is stolen, the owner that had the item stolen would need to report the stolen product by updating a stolen RFID database using the Trusted Authority 370 or Credit Card Company. The owner would be authenticated before they can list an item as being stolen. This would prevent people from entering into the stolen RFID database an RFID for a product they never actually owned.

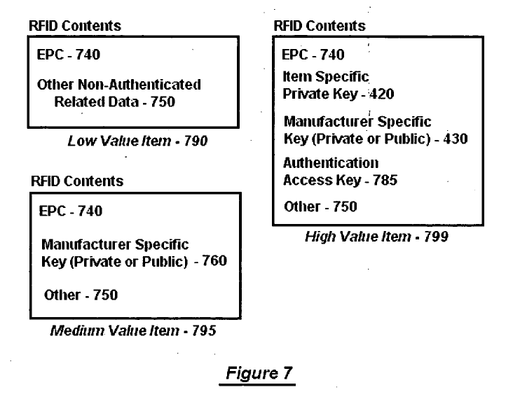

FIG. 7 shows the different keys and data stored in product RFIDs for products with different values that will require different authentication levels. Low priced inexpensive items will use standard RFIDs with out any authentication and without cryptographically secure authentication.

For low cost items the standard RFID data contents includes an Electronic Product Code 740 and other RFID related data shown as other non-authentication related data 750 in the RFID contents for Low Value Items 790. Reference 790 shows what can be considered an industry standard RFID content description. This invention will allow the RFID for Low-Value Items 790 to be read from Phone 330 and have the EPC code validated and/or stored in RFID data storage for later recall by the owner of phone 330 for example, when a phone 330 owner desires to purchase an identical product. This invention provides RFID content readout and display on phone 330. Information such as the expiration date for a product contained in other non-authentication related data 750 can be valuable to a phone 330 owner when purchasing products. Other non-authentication related data 750 can include temperature for temperature sensitive products, humidity for humidity sensitive products. Phone 330 can use EPC 740 value to determine if recall or safety alerts are associated with an item.

Medium value items costing in the range of $10 to maybe $40 may contain the keys shown in block 795. Medium value item 795 includes all the RFID data of Low Value Item 790 and additional data 760 that allows the product manufacturer to be authenticated, but not the product itself. Manufacturer specific 760 data can be either a public or private key and different authentication methods can be used to validate Manufacturer specific 760 data or key. The preferred data stored in Manufacturer specific 760 data is a private key associated with the product manufacturer or product line for a specific manufacturer.

When a manufacturer specific private key is stored in 760 this will be referred to as Manufacturer specific private key 760 stored in RFID. Manufacturer specific private key 760 is used to authenticate the product manufacturer using the manufacturer's public key for this product line or for the manufacturer published by a certificate authority such as Verisign or a Trusted Authority. Authentication of the manufacturer will be performed as described in the section titled Phase 1: Authenticate Manufacturer above.

FIG. 7 identifies the RFID contents for High Value Items 799. In High Value Item 799 RFID 320 contents will contain an EPC 740 value and an Item Specific Private Key 420 that is unique for this individual item and is not used by other products made by this manufacturer. The Item Specific Private Key 420 will be used during the authenticate process to uniquely identify this single item by having the RFID 320 in a product digitally sign or respond to a cryptographic challenge using the Item Specific Private Key 420 when being authenticated by Trusted Authority 370 or Product Manufacturer or Distributor 380. For High Value Item 799 an optional Authentication Access Key 785 is shown that is used as a password to protect the RFID from unauthorized access in that the Authentication Access Key 785 must be entered before the RFID 320 will respond to authentication requests. Any secure login or secure password protection can be used to process the Authentication Access Key 785 unlocking of the RFID 320 to allow RFID 320 to respond to authentication requests and challenges. Having a method and password or key that can be used to unlock the RFID to allow authentication is another important element of this invention. Once again, the Authentication Access Key 785 is optional. Standard RFID data can also be contained in High Value Item 799 RFID 320.

Regardless of how the application is distributed between being built into the cellular phone or provided by a network or Internet based application, script, or web service, the cellular phone 330 shall contain secure access method to perform authentication and product RFID and information lookup and access.

Additional/Optional Authentication Specifications:

Challenge response (server sends encrypted or clear text challenge, client responds with MD4 (static value (such as card ID)/salt and password or other value)

Session key enacted—Server sends challenge—client responds with public key encrypted message hash and session key—server verifies client response

Smart card/phone ID 150 (also known as Subscriber Identity Module SIM) to authenticate the terminal and store SECURE RFID AUTHENTICATION SYSTEM keys in SIM module. Like disparate security hierarchies from web and cell phone using SIM module and RFID information.

Additional Data Accumulation Specifics:

Provide option to log or not log the purchase of an item.

Standardized reader or interface in cell phone provides automated expense tracking for travel and purchases.

Automatic tracking (via email or web service) to employee expense reports where a purchase.

Provide flexible user purchase logging routines to data accumulation agencies, businesses, databases, etc.

Share/Distribute purchase details to non-authenticating entities such as:
Insurance Companies
Service Providers
Resellers & brokers
Banks & Collateral Agencies

Todo:

Show Key Hierarchies for low-value, medium, and high value items. Add more details on ebay buyer protection.
1. Substitute SECURE RFID AUTHENTICATION SYSTEM with Secure RFID Authentication System
2. Add signed data, encrypted data (conventional encryption), private/public key encrypted data, digested (hashed) data, and Authenticated (MAC'd) data
3. In addition to private key, manufacturing data that is in addition to keys
4. FIPS 196 and other standards based authentication, encryption, key management
5. Challenge response (server sends encrypted or clear text challenge, client responds with MD4 (static value (such as card ID)/salt and password or other value)
6. Session key—Server sends challenge—client responds with public key encrypted message hash and session key—server verifies client response
7. Use smart card/phone ID 150 (also known as Subscriber Identity Module SIM) to authenticate the terminal and store SECURE RFID AUTHENTICATION SYSTEM keys in SIM module. Like disparate security hierarchies from web and cell phone using SIM module and RFID information.
8. Use smart card /phone ID 150 (also known as Subscriber Identity Module SIM) to authenticate the terminal and store SECURE RFID AUTHENTICATION SYSTEM keys in SIM module. Like disparate security hierarchies from web and cell phone using SIM module and RFID information with 3^{rd} party trusted authority linked to code image in Cellular Phone.
9. Authentication service in phone must be verified from Cellular Phone Network service provider.
10. SIM ID linkage with Cell Phone Service Provider and Trusted Authority
11. Add these techniques to PCs
12. Support SIM/WIM
13. Option to log or not log the purchase of an item. Standardized reader or interface in cell phone provides automated expense tracking for travel and purchases.
14. Automatic tracking (via email or web service) to employee expense reports where a purchase

Describe Details on the Following:

Regardless of how the application is distributed between being built into the cellular phone or provided by a network or Internet based application, script, or web service, the cellular phone 330 shall contain secure access method to perform authentication and product RFID and information lookup and access.

1. During item authentication—Cellular phone will use the public key distributed by Trusted Authority-giving the consumer the confidence that the Trusted Authority validates the product manufacturer.

2. Code signature of software codes added to Cellular phone to perform Authentication. Phone Image allowing Trusted Authority to authenticate Cell Phone.

3. Cell phone smart card or phone ID 150 is provided by the Cellular Phone company or by customer during registration process. This process provides automatic purchase registration by Trusted Authority.

4. Cell phone smart card or phone ID 150 is provided by Cellular Phone company or by customer during registration process. This process provides automatic purchase registration by Trusted Authority. Registration can occur automatically by having Cell phone owner call or network connect to Trusted Authority and having Cell phone provide the Smart Card/Phone ID data 150 to Trusted Authority. Data transfer can be performed using any standard data transfer method.

5. Trusted Authority will store identity of Cell Phone owner and link RFID information of purchased product to the owner of the Cell Phone.

6. Method to disable the linking of RFID for purchased product with Cell Phone Customer for privacy reasons.

7. Claim Manufacturer has optional Private/Public key pair with Trusted Authority, allowing Trusted Authority to authenticate the manufacturer.

8. Product Line private/public key pair allowing products RFID 320 to contain optional Product Line Public Key to allow product to authenticate the manufacturer using the Manufacturer's Product Line public key embedded into RFID 320.

9. Trusted Authority can validate manufacturer information contained with RFID 320. Examples of information that Trusted Authority can verify include the registered public key for the products manufacturer and/or the manufacturer's public key for the item.

10. Cellular Phone access and authentication protection into a network comprised of: Manufacturers, Credit Card Companies, Trusted Authorities, Banks, Distributors and Retailers.

11. Product embedded or attached RFID item level authentication to detect counterfeit, stolen, warranty voided products prior to purchase via cell phone enacted at a user's discretion.

12. Utilize product authentication at on-line real-time auctions such as eBay to detect stolen merchandise prior to purchase.

13. Record a product's RFID tag details prior to bid/purchase at an on-line real-time auction such as eBay.

14. Verify that a product's RFID tag details recorded at time of bid/purchase at an on-line real-time auction such as eBay matches the RFID tag data at time of delivery.

15. Establish purchased product logs and statements in a secure cell phone network.

16. Distribute purchased item data to user specified entities.

17. Establish an ownership record to items purchased within the Secure RFID Authentication System.

18. Authenticate a user's cell phone within the Secure RFID Authentication System.

19. Provide the means to establish a secure collection of desired products by storing the item's RFID tag data into the authenticated cell phone.
